(19) United States
(12) Patent Application Publication
(10) Pub. No.: US 2005/0189866 A1
(43) Pub. Date: Sep. 1, 2005

(54) Flat panel display apparatus

(75) Inventors: Yoshie Kodera, Chigasaki (JP); Tetsu Ohishi, Hiratsuka (JP); Toshimitsu Watanabe, Yokohama (JP); Mutsumi Suzuki, Kodaira (JP); Masakazu Sagawa, Inagi (JP); Akinori Maeda, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi Ltd., Tokyo (JP)

(21) Appl. No.: 11/046,437

(22) Filed: Jan. 27, 2005

(30) Foreign Application Priority Data
Jan. 28, 2004 (JP) 2004-019915

(51) Int. Cl. H01J 1/62; H01J 63/04

(52) U.S. Cl. 313/495

(57) ABSTRACT

A flat panel display apparatus includes a rear substrate in which a number of cold cathode devices for emitting electrons are formed on an insulative substrate; a display substrate in which phosphors are arranged in a matrix shape on a translucent substrate; supporting members which are arranged between the rear substrate and the display substrate and maintain intervals between them; and frame members, in which a space surrounded by the rear substrate, the display substrate, and the frame members is set to a vacuum atmosphere. It then becomes possible to provide an apparatus in which there is no remarkable change between a scanning line resistance value in the scanning line direction in a portion with spacers and that in a portion without a spacer, a luminance variation can be reduced, and the apparatus has a conduction connection structure of the spacers and the scanning lines.

### BACKGROUND OF THE INVENTION

1. Field of the Invention

The invention relates to a flat panel display apparatus and, more particularly, to a field emission display (hereinafter, abbreviated to an “FED”) as a flat panel display apparatus in which electron sources in each of which a number of cold cathode devices for emitting electrons are arranged in a matrix shape are enclosed in an airtight vessel.

2. Description of the Related Art

In recent years, an FED as a flat panel display apparatus in that electron sources in each of which electron emission devices of cold cathode devices are arranged in a matrix shape are enclosed in an airtight vessel (vacuum vessel) is highlighted as a flat panel display apparatus of a spontaneous light emitting type whose electric power consumption is small and which has luminance and contrast similar to those of a cathode ray tube. As electron emission devices, a Surface-conduction Electron-emitter Display device (hereinafter, abbreviated to an “SED type”), a Field Electron-emitter Display device (hereinafter, abbreviated to an “FE type”), a Metal-Insulator-Metal type electron emission device (hereinafter, abbreviated to an “MIM type”), and the like have been known. As an FE type, a spint type mainly made of a metal such as Mo or the like or a semiconductor material such as Si or the like and a CNT type using a carbon-nanotube (CNT) as an electron source can be mentioned. The SED type has been disclosed in, for example, JP-A-2000-164129. The MIM type has been disclosed in, for example, JP-A-2001-101965. A background art will be described hereinbelow by using the MIM type FED for simplicity of explanation. The background art which is mentioned here has been disclosed in, for example, JP-A-2001-101965.

The FED is constructed in such a manner that a rear substrate (also referred to as a cathode substrate) in which electron emission devices of cold cathode devices are arranged in a matrix shape on an insulative substrate and used as electron sources and a display substrate (also referred to as a anode substrate) in which phosphors of three primary colors R, G, and B which emit light by irradiation of electron beams from the electron sources are formed on a translucent substrate such as glass or the like and a metal back as a thin film of aluminum which protects deterioration of the phosphor due to the irradiation of the electron beam and functions as an anode electrode is formed on the phosphors are arranged so as to face each other at a predetermined interval, a supporting frame is seal-bonded to a peripheral edge portion between the rear substrate and the display substrate by frit glass or the like, and an inside of the FED is set into a vacuum airtight state of about 10⁻⁵ to 10⁻⁷ torr.

In the case of the MIM type, as shown in FIG. 17 of JP-A-2001-101965, the electron emission devices are arranged at crossing points of a plurality of lower electrode lines and upper electrode lines which are formed on the rear substrate through an insulating film so as to cross perpendicularly, the upper electrode lines in the portions excluding opening portions of upper electrodes serving as electron emitting portions are coated with a surface protecting film of an insulating layer, and a metal film of, for example, 10 nm or less which is not electrically connected to the upper electrodes is formed over the upper electrode lines. When a predetermined voltage is applied between the lower electrode and the upper electrode, electrons transmit through a tunnel insulating film from the lower electrode owing to a tunnel phenomenon, reach the upper electrode, and are emitted into a vacuum from the electron emitting portion. As shown in FIG. 22 of JP-A-2001-101965, the lower electrode lines in the row direction (lateral direction on the paper of the drawing) are used as scanning lines and the upper electrode lines in the column direction (vertical direction on the paper of the drawing) are used as signal lines, respectively.

Since the inside of the FED is filled with a vacuum atmosphere, in the case where the FED is used as a display apparatus of a large display screen, it is necessary to arrange a plurality of supporting members (hereinafter, referred to as “spacers”) between the display substrate and the rear substrate so that the vacuum chamber is not destroyed by a difference between the inner atmospheric pressure and the outer atmospheric pressure.

The spacer (for example, a flat shape) is constructed in such a manner that the display substrate side is arranged on black light absorbing layers provided among phosphors of R, G, and B constructing pixels in order to improve the contrast, for example, on metal backs in a matrix-shaped black matrix and the rear substrate side is arranged in parallel on a metal film formed on the surface protecting films of the upper electrode lines so as not to obstruct a trajectory of the electrons which reach the phosphor from the electron emission devices as electron sources.

The spacer is charged by the action of the electrons from the electron emission devices. Therefore, at a place near the spacer, the trajectory of the electrons which are emitted from the electron emission devices is bent and a phenomenon in which an image is distorted occurs. To prevent such a phenomenon, as disclosed in JP-A-57-118355 or JP-A-2002-260563, tin oxide of a high resistance film, a mixed crystal thin film of tin oxide and indium oxide, or a conductive film as a metal film for prevention of the charging is formed on the surface of the spacer, thereby allowing a microcurrent to flow on the spacer surface. For this purpose, the spacer is electrically connected to the metal film and the metal back between the upper electrode lines by a conductive adhesive material (for example, conductive frit glass in which a conductive material such as a metal or the like has been mixed).

Thus, an anode voltage (for example, 5 to 10 kV) applied to the metal back flows into the metal film of the rear substrate through the spacer. Ordinarily, the metal film is connected to a ground potential and a current from an anode electrode of a high voltage flows into the ground potential.

A whole constructional diagram of the FED mentioned above is shown in FIG. 21 of JP-A-2001-101965.

### SUMMARY OF THE INVENTION

In the FED, when a diagonal size of its display panel exceeds 5 inches, in order to support the atmospheric pressure, it is necessary to arrange a plurality of spacers made of the insulative material as reinforcing members between the display substrate and the rear substrate at intervals of a few centimeters. A part of the electrons emitted from the electron source devices collide with those spacers and cause charging. To prevent it, a high resistance film is formed on the spacer and slight conductivity is given thereto, thereby eliminating the charge on the spacer surface. Therefore, it is necessary to electrically connect the spacer to the metal back of the display substrate side and the metal film on the surface protecting film of the rear substrate side. In the metal film to which the ground potential is applied on the rear substrate side, since a thickness is equal to or less than 10 nm and adhesion strength to the surface protecting film is weak, if a pressure from the spacer is applied, disconnection is liable to easily occur. To prevent it, a third wiring that is independent of the signal line (upper electrode line) and the scanning line (lower electrode line) needs to be formed on the surface protecting film as a ground wiring for the spacer.

However, if a triple-layer wiring structure in which the signal line, the scanning line, and the independent third wiring are arranged on the rear substrate side is used as mentioned above, since a manufacturing step is inevitably longer than that of a double-layer wiring, deterioration in yield and an increase in manufacturing costs cause a problem.

There is also a problem of a voltage drop of a scanning line electrode. Such a problem will be described hereinbelow. In the case of displaying an image by the FED, a driving method called a line-sequential driving system is used as a standard. According to such a system, when still images of 60 frames per second are displayed, the display in each frame is executed every scanning line (horizontal direction). Therefore, all of the cold cathode electron sources corresponding to the number of signal lines and existing on the same scanning line are simultaneously made operative.

At the time of the operation, a current obtained by multiplying a current which is consumed by the cold cathode electron sources included in sub-pixels by the total number of signal lines and the number (3) of colors (RGB) flows in the scanning line. Since such a scanning line current causes a voltage drop along the scanning line due to a wiring resistance, the uniform operation of the cold cathode electron sources is obstructed.

A degree of the voltage drop differs depending on the system of the cold cathode electron sources. For example, in the spint type of the FE type, since almost of 100% of the electron source current is dispersed into the vacuum and reaches an anode (fluorescent screen), a current flowing in a gate line (scanning line) is extremely small and an influence of the voltage drop is small. On the other hand, in the SED type, the MIM type serving as a hot electron type, or the like, when the electron source current of at most a few % reaches the anode, most of the current flows as a reactive current into the gate line (scanning line). Therefore, when comparing with the same anode current, those electron sources are more easily influenced by the voltage drop than the spint type.

Hitherto, in the FED, the scanning lines are always selected as lower electrodes. This is because in the hot electron type electron sources, a film thickness of the upper electrode has to be set to a very thin film of about a few nm in order to reduce scattering of the hot electrons and since the sheet resistance is inevitably equal to or higher than 100 Ω/□, it is improper to use the upper electrodes as scanning lines.

As for the lower electrodes, since the lower electrode is made of an aluminum film whose thickness is equal to about 300 nm and a pitch of the scanning lines is equal to about three times as large as that of the signal lines and has an enough space, the sheet resistance can be suppressed to hundreds of mΩ/□ by assuring a sufficient line width. Therefore, it is very natural to select the lower electrodes as scanning lines.

However, according to such a construction, it has been found that it is difficult to suppress the voltage drop which becomes more typical in association with an enlargement of a display screen size.

In the FED, a scanning line current Is which is required to obtain predetermined luminance can be expressed by the following equation (1).
Is=Je×S/α (1)
where,
Je: anode current density to obtain the predetermined luminance
S: area of the display screen
α: ratio of an anode current which occupies an emitter current (also called an electron emission efficiency)

Thus, an amount of voltage drop (Vdrop) which is caused across the scanning line can be expressed by the following equation (2).
Vdrop=½×Id×Rs×(L/W) (2)
where,
Id: drive current
Rs: sheet resistance of the scanning line
L: length of long side of the display screen
W: width of scanning line

It will be understood that when it is assumed that the display screen size is enlarged while keeping resolution constant, the voltage drop amount Vdrop increases in proportion to Rs×S/α. To suppress it, the following measures are taken.

(1) An electron emission coefficient is raised. However, although it is proper to thin a thickness of upper electrode, since there is a lower limitation, it is impossible to reduce the voltage drop amount in proportion.

(2) The sheet resistance Rs is reduced. To realize it, a thickness of lower electrode is increased and resistivity is reduced. However, improvement cannot be expected because of the following reasons (a) to (c).
(a) Since it is necessary that the tunnel insulating film formed between the lower electrode and the upper electrode of the electron emitting portion region is made from anodized alumina, it is difficult to change it to another material.
(b) Although the resistance of aluminum can be reduced by changing a film forming condition (for example, a temperature of the substrate is raised), smoothness of the film surface deteriorates and the reliability of the tunnel insulating film deteriorates.
(c) If the film thickness is increased, hillocks and voids of the aluminum wiring are easily caused in a heat treatment step. It is indispensable to maintain the surface smoothness of the electrode so as to prevent the tunnel insulating film from being destroyed.

From the above viewpoints, a new construction which can sufficiently reduce the sheet resistance of the scanning line is needed to enable the MIM type electron source to cope with the display of a large display screen.

The invention is made in consideration of the above circumstances and it is an object of the invention to provide a flat panel display apparatus having a conduction connecting structure of spacers and scanning lines, in which the above problems can be solved, there is no remarkable change between a resistance value of the scanning line in the scanning line direction in a portion with the spacer and that in a portion without a spacer and a luminance variation can be reduced.

To accomplish the above object, according to the invention, there is provided a flat panel display apparatus comprising: a rear substrate in which a number of cold cathode devices for emitting electrons are formed on an insulative substrate; a display substrate in which phosphors which are excited by electron beams from the cold cathode devices and emit light and are arranged in a matrix shape are formed on a translucent substrate arranged so as to face the rear substrate, light absorbing layers for improving contrast are formed among the phosphors, and a metal back to accelerate the electron beams is formed on the surfaces of the phosphors and the light absorbing layers on the side of the cold cathode devices; a plurality of supporting members which are perpendicularly arranged between the rear substrate and the display substrate and maintain intervals between them; and frame members, in which space surrounded by the rear substrate, the display substrate, and the frame members is set to a vacuum atmosphere, wherein the rear substrate has the cold cathode devices in crossing portions of a plurality of row-directional wirings and a plurality of column-directional wirings which perpendicularly cross and the supporting members are adhered and arranged in parallel on the row-directional wirings or the column-directional wirings with an anisotropic conductive adhesive material.

That is, according to the invention, there is provided a flat panel display apparatus comprising: a rear substrate in which a number of cold cathode devices for emitting electrons are formed on an insulative substrate; a display substrate which is arranged so as to face the rear substrate and in which phosphors that are excited by electron beams from the cold cathode devices and emit light are arranged in a matrix shape on a translucent substrate; supporting members which are arranged between the rear substrate and the display substrate and maintain intervals between them; and frame members, in which a space surrounded by the rear substrate, the display substrate, and the frame members is set to a vacuum atmosphere, wherein the rear substrate has the cold cathode devices in crossing portions of row-directional wirings and column-directional wirings which perpendicularly cross and the supporting members are adhered and arranged on the row-directional wirings or the column-directional wirings with an anisotropic conductive adhesive material.

According to the invention, the supporting members have flat portions and the flat portions are arranged on the row-directional wirings in parallel with the wiring direction.

According to the invention, in the anisotropic conductive adhesive material, a resistance value in the direction which perpendicularly crosses is two or more digits higher than that in the interval maintaining direction of the supporting members.

In the invention, since the anisotropic conductive adhesive material is used for conduction connection of the supporting members and predetermined directional wirings on which the supporting members are arranged, a resistance value R_{T} in the thickness direction of the conductive adhesive material can be reduced, a plane-directional resistance value R_{L} in the direction along the predetermined directional wirings which perpendicularly crosses the thickness direction of the conductive adhesive material can be increased, and an influence of the resistance value R_{L} of a resistor which is in parallel with a predetermined directional wiring resistor R can be ignored. Thus, the luminance variation occurring in the portion with the spacer and the portion without a spacer can be reduced.

The invention is suitable particularly in the case where the wirings where the supporting members are arranged are the row-directional wirings, that is, the scanning lines.

According to the invention, it is possible to provide a flat panel display apparatus having a conduction connecting structure of the supporting members and the scanning lines, in which there is no remarkable change between the resistance value of the scanning line in the scanning line direction in the portion with the spacer and that in the portion without a spacer and the luminance variation can be reduced.

### BRIEF DESCRIPTION OF THE DRAWINGS

FIGS. 1A, 1B, and 1C are schematic connection constructional diagrams of scanning lines and spacers formed on a rear substrate of a flat panel display apparatus according to an embodiment of the invention;

FIG. 2 is a schematic diagram showing a relation between a plane-directional resistance value and a thickness-directional resistance value of an anisotropic conductive adhesive material;

FIGS. 3A, 3B, and 3C are connecting step diagrams of the spacers and the scanning lines;

FIG. 4 is a cross sectional view of a flat panel display apparatus of the invention;

FIGS. 5A, 5B and 5C are manufacturing step diagrams of an interlayer insulating film and connection electrodes;

FIGS. 6A, 6B, and 6C are manufacturing step diagrams of an upper electrode power supply wiring;

FIGS. 7A, 7B, and 7C are manufacturing step diagrams in the case of forming an opening portion into the connection electrode;

FIGS. 8A, 8B, and 8C are manufacturing step diagrams in the case of forming an opening portion into the interlayer insulating film;

FIGS. 9A, 9B, and 9C are constructional diagrams of one MIM type electron emission device formed on the rear substrate;

FIGS. 10A, 10B, and 10C are constructional diagrams of the rear substrate on which a plurality of MIM type electron emission devices are arranged in a matrix shape; and

FIGS. 11A and 11B are diagrams showing an example of a conventional flat panel display apparatus.

### DETAILED DESCRIPTION OF THE EMBODIMENT

A best mode for carrying out the invention will be described hereinbelow.

An embodiment of a flat panel display apparatus of the invention will be described with reference to the drawings.

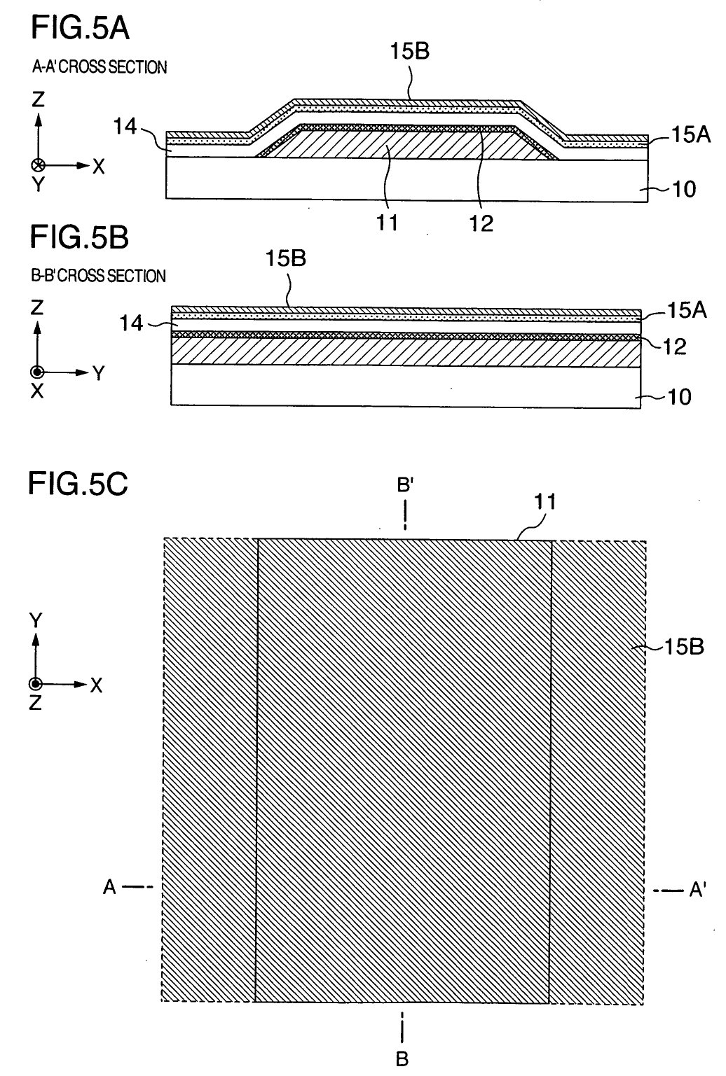

First, an example of the flat panel display apparatus to which the invention is applied will be explained. With respect to this flat panel display apparatus, the applicant et al. of the present invention have already proposed such devices in Japanese Patent Application No. 2002-216227 and JP-A-2004-246317. Their outlines will be described hereinbelow with reference to FIGS. 5A to 11B.

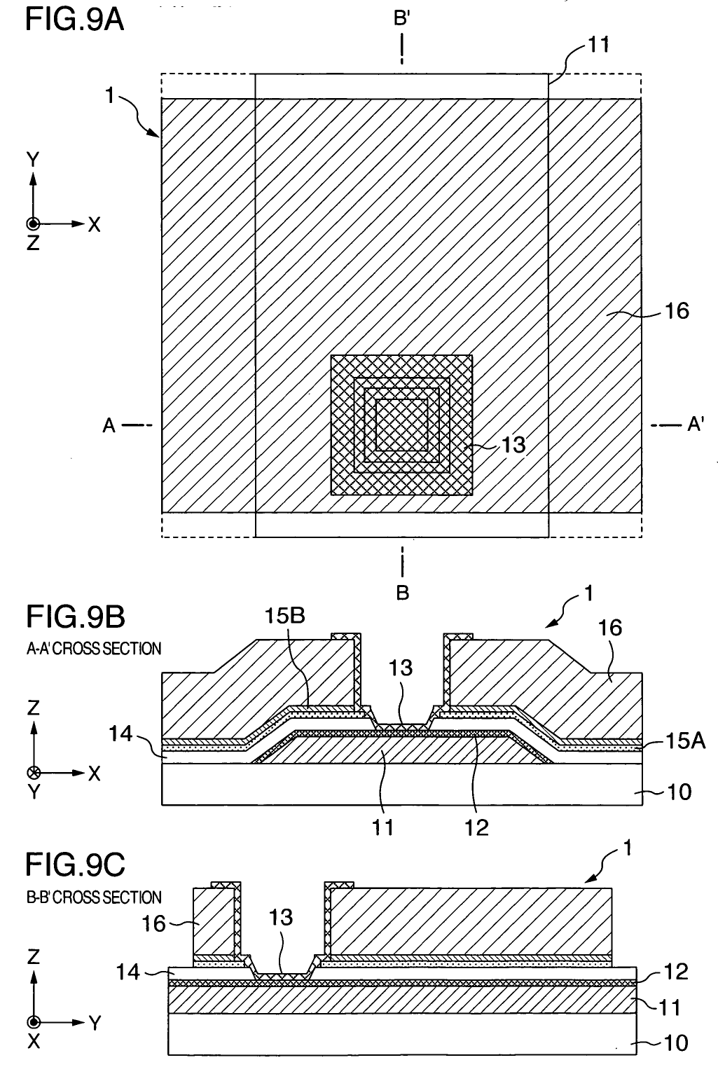

FIGS. 9A, 9B, and 9C are constructional diagrams of one MIM type electron emission device formed on a rear substrate. FIG. 9A is a top constructional diagram. FIG. 9B is a cross sectional constructional diagram taken along the line A-A′ in FIG. 9A, that is, a cross sectional constructional diagram which perpendicularly crosses a stripe-shaped lower electrode extending in the Y direction. FIG. 9C is a cross sectional constructional diagram taken along the line B-B′ in FIG. 9A, that is, a cross sectional view which is parallel with the Y direction.

In FIGS. 9A, 9B, and 9C, a lower electrode 11 as a metal film of, for example, Al or Al alloy having a thickness of, for example, 300 nm is formed in a stripe shape on (Z direction) an insulative substrate 10 of glass or the like in the Y direction as an obverse/reverse direction that is perpendicular to the paper surface of FIG. 9B. After a film was formed by, for example, sputtering, the lower electrode 11 is formed in a stripe shape by a photolithography step and an etching step. An insulating film 12 whose thickness is equal to, for example, about 10 nm is formed on the upper surface of the lower electrode 11 by anodization. In FIGS. 9A, 9B, and 9C, reference numeral 1 denotes a rear substrate on which an MIM type electron emission device has been formed.

An interlayer insulating film 14 and subsequent portions will be described with reference to manufacturing step diagrams because their constructions are complicated. FIGS. 5A and 5B are manufacturing step diagrams of the interlayer insulating film and connection electrodes. FIG. 5A is a cross sectional constructional diagram taken along the line A-A′ of the electrode shown in FIG. 5C. FIG. 5B is a cross sectional constructional diagram taken along the line B-B′ of the electrode shown in FIG. 5C. In FIGS. 5A and 5B, the interlayer insulating film 14 of Si₃N₄, a connection electrode lower layer 15A of Cr for assuring an adhesive property between a connection electrode upper layer 15B and the interlayer insulating film 14 serving as a substratum layer, and the connection electrode upper layer 15B of Cu serving as a seed film of plating are continuously formed as films onto the insulating film 12 by sputtering. A thickness of connection electrode lower layer 15A of Cr is set to a thin film of about tens of nm so that an upper electrode 13 which is formed later is not disconnected at a step of the connection electrode lower layer 15A.

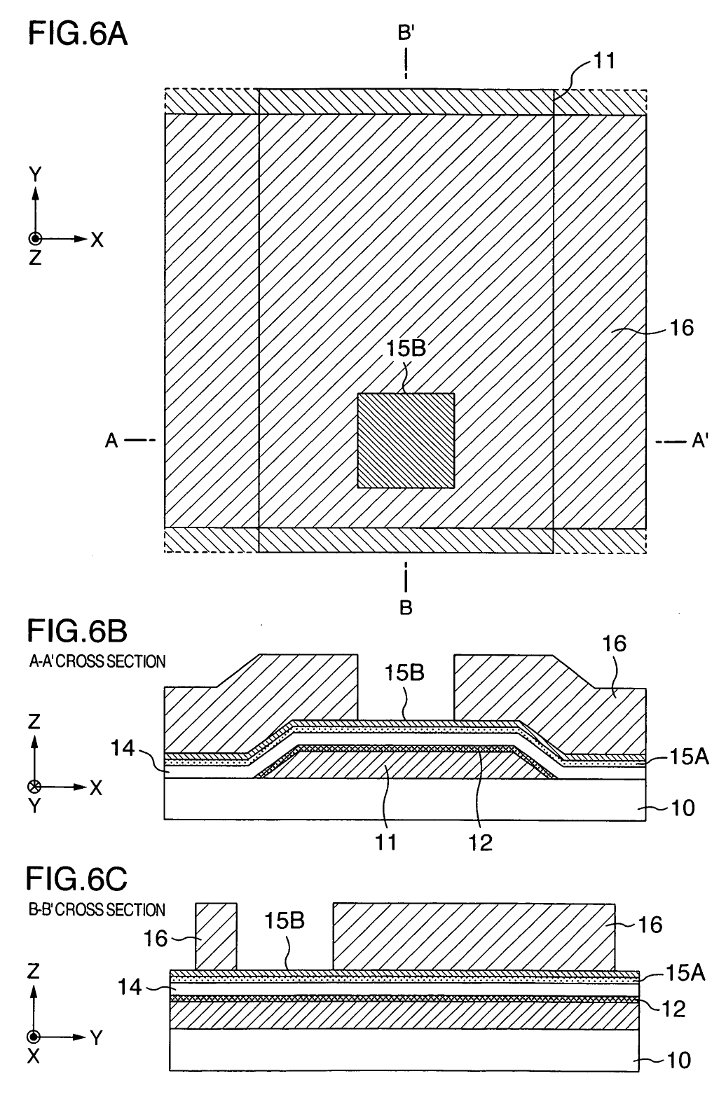

FIGS. 6A, 6B, and 6C are manufacturing step diagrams of an upper electrode power supply wiring. FIG. 6A is a top constructional diagram. FIG. 6B is a cross sectional constructional diagram taken along the line A-A′ in FIG. 6A. FIG. 6C is a cross sectional constructional diagram taken along the line B-B′ in FIG. 6A. In FIGS. 6A, 6B, and 6C, after a resist pattern is formed as a plating mask onto the connection electrode upper layer 15B, Cu is selectively and thickly deposited onto the region of the layer 15B by electroplating or electroless plating while excluding an opening portion serving as an electron emitting portion, thereby forming an upper electrode power supply wiring 16 made of a Cu layer having a desired thickness of, for example, 5 μm. The diagrams show the state after the thick layer forming plating of Cu was completed and the plating mask (resist pattern) was removed. The resist pattern is a square pattern to form a region of the electron emitting portion of the electron source.

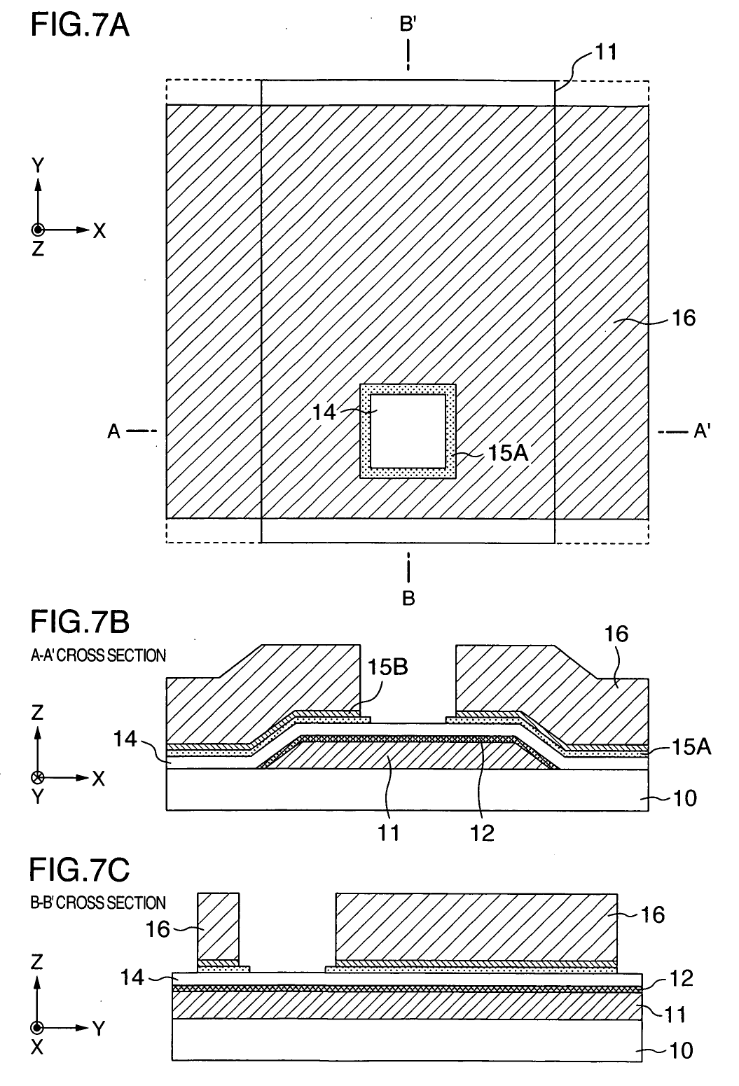

FIGS. 7A, 7B, and 7C are manufacturing step diagrams in the case of forming an opening portion into the connection electrode. FIG. 7A is a top constructional diagram. FIG. 7B is a cross sectional constructional diagram taken along the line A-A′ in FIG. 7A. FIG. 7C is a cross sectional constructional diagram taken along the line B-B′ in FIG. 7A. In FIGS. 7A, 7B, and 7C, by Cu-etching the whole surface of the thin connection electrode upper layer 15B, it is worked into a stripe shape in the direction (X direction) which perpendicularly crosses the lower electrode 11. Since the connection electrode upper layer 15B is extremely thinner than the upper electrode power supply wiring 16, only the connection electrode upper layer 15B can be selectively removed by controlling the etching time.

Subsequently, a resist pattern in a square frame-shape is formed onto the connection electrode lower layer 15A which forms the electron emitting portion region (square concave portion) of the electron source and the connection electrode lower layer 15A of Cr exposed to the inside of the frame-shaped pattern is selectively worked by wet etching and removed.

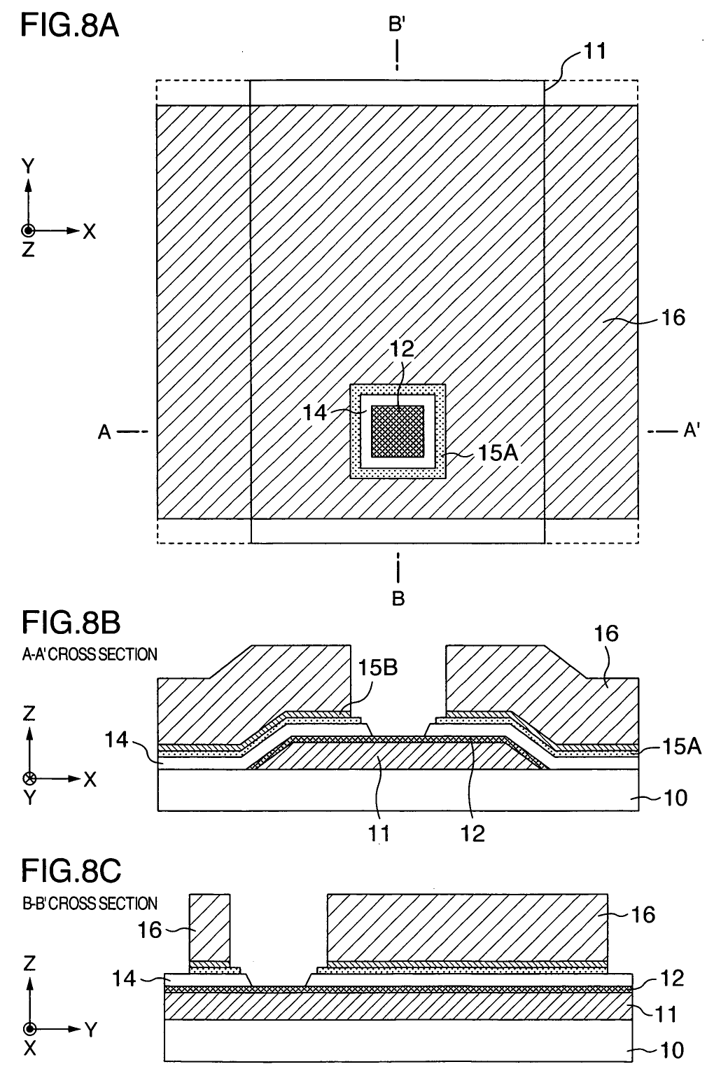

FIGS. 8A, 8B, and 8C are manufacturing step diagrams in the case of forming an opening portion into the interlayer insulating film. FIG. 8A is a top constructional diagram. FIG. 8B is a cross sectional constructional diagram taken along the line A-A′ in FIG. 8A. FIG. 8C is a cross sectional constructional diagram taken along the line B-B′ in FIG. 8A. In FIGS. 8A, 8B, and 8C, in order to open an electron emitting portion into the concave portion where the electron emitting region of the electron source is formed, a part of the interlayer insulating film 14 is opened by the photolithography and dry etching, thereby exposing the tunnel insulating film 12. Mixed gases of CF₄ and O₂ are suitable as an etching gas. A working damage due to the etching is concealed by executing the anodization again to the exposed tunnel insulating film 12.

Returning to FIGS. 9A to 9C, the upper electrode 13 having a film thickness of a few nm is formed onto the exposed tunnel insulating film 12 by a sputtering method, so that the rear substrate is completed. For example, a laminated film of Ir, Pt, and Au is used as a material of the upper electrode 13.

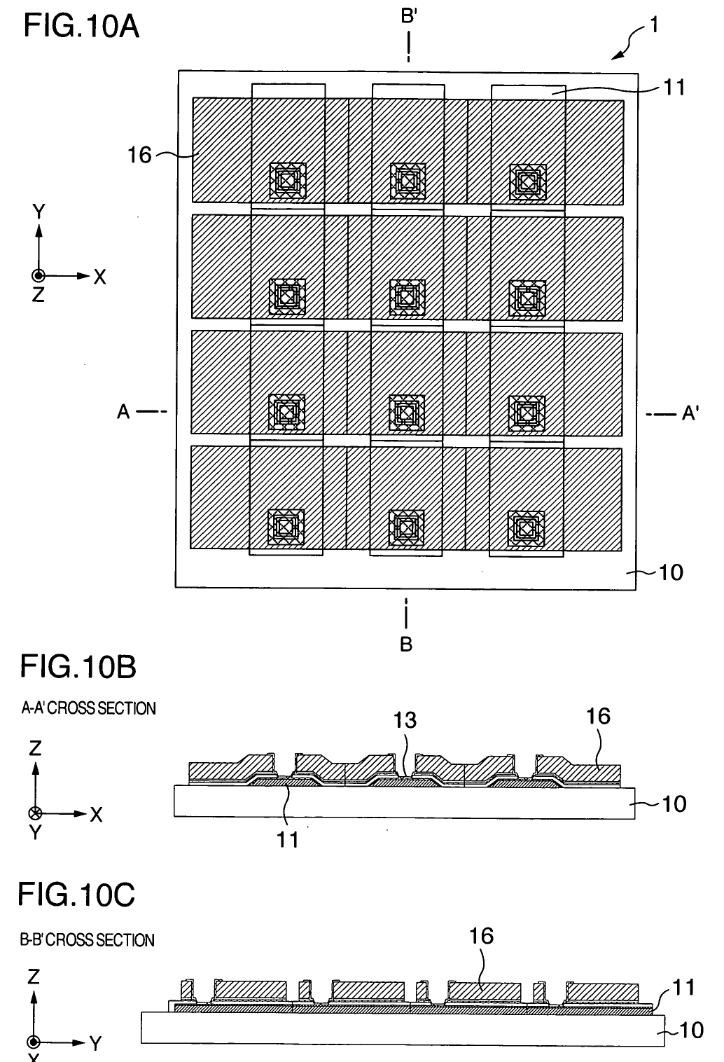

The rear substrate on which a plurality of MIM type electron emission devices are arranged in a matrix shape (it is conveniently illustrated here by a matrix comprising 3×4 dots for simplicity of explanation) is shown in FIGS. 10A, 10B, and 10C. FIG. 10A is a top constructional diagram. FIG. 10B is a cross sectional constructional diagram taken along the line A-A′, that is, a cross sectional constructional diagram which perpendicularly crosses the stripe-shaped lower electrode extending in the Y direction. FIG. 10C is a cross sectional constructional diagram taken along the line B-B′, that is, a cross sectional view which is parallel with the Y direction. In this example, unlike the conventional apparatus, since a thin metal film which is formed on a surface protecting film of the upper electrode side and gives a ground potential does not exist, even if the spacer is directly-arranged on the upper electrode power supply wiring 16 whose film thickness is thick, it is not peeled off and the wiring 16 is not disconnected. Since the upper electrode power supply wiring 16 is made of the Cu layer having a thick film thickness of 5 μm and is constructed so that its wiring resistance can be sufficiently reduced, the upper electrode power supply wiring 16 can be used as a scanning line. Naturally, the lower electrode is used as a signal line. Since the upper electrode power supply wiring 16 is used as a scanning line, there is also such an effect that a plate thickness of, for example, flat plate-shaped spacer which is arranged on the scanning line in parallel therewith can be made thicker than that in the case where it is arranged in parallel.

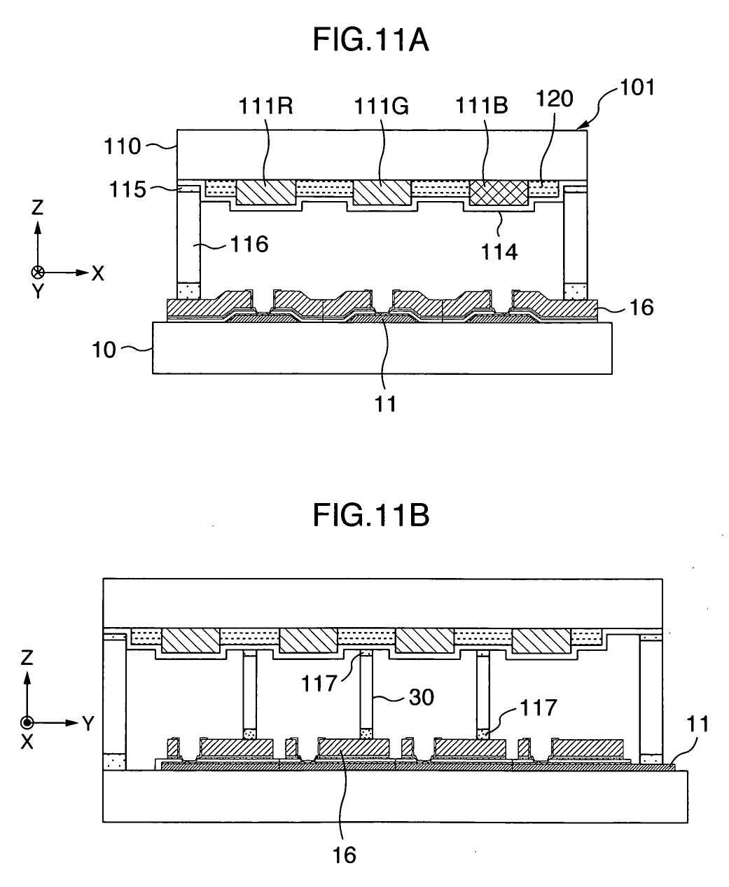

An example of a flat panel display apparatus in which a rear substrate on that a plurality of electron emission devices are arranged in a matrix shape and a display substrate are arranged so as to face each other at a predetermined interval is shown in FIGS. 11A and 11B. FIG. 11A is a cross sectional view showing the state in the case where the display apparatus is cut at a plane which perpendicularly crosses the stripe-shaped lower electrode. FIG. 11B is a cross sectional view showing the state in the case where the display apparatus is cut at a plane which is parallel with the stripe-shaped lower electrode. In FIGS. 11A and 11B, a display substrate 101 comprises: a translucent substrate 110; phosphors 111 of R, G, and B coated onto an inner surface of the substrate 101; a black matrix 120 as a black light absorber provided among the phosphors; and a metal back 114 formed on the phosphors and the black matrix. Peripheral portions of the display substrate and the rear substrate are seal-bonded by supporting frames 116 by using frit glass 115. One end of each spacer 30 is adhered onto the upper electrode power supply wiring 16 as a scanning line and the other is adhered onto the metal back 114 by a conductive adhesive material (for example, conductive frit glass).

In the case of applying the above construction to a panel of 17 inches in which an aspect ratio is equal to 4:3 and the number of pixels is equal to 640×480 (VGA), a conductor width of the upper electrode power supply wiring 16 is equal to about 200 μm and its wiring film thickness is equal to 5 μm. Therefore, a scanning line resistance is equal to about 5.9Ω because a specific resistance of Cu is equal to 1.7 μΩ·cm. When a potential difference of about 10V is applied between the lower electrode and the upper electrode, the current flowing in the upper electrode power supply wiring as a scanning line is equal to about 0.1 A.

In the case where, for example, a conductive adhesive material of a metal paste whose specific resistance is equal to about 3 μΩ·cm as disclosed in JP-A-2003-115216 is used as a conductive adhesive material for conduction-connecting the spacer onto the scanning line, in the scanning line portion where the spacer is arranged, a resistance whose specific resistance is equal to about 3 μΩ·cm based on the conductive adhesive material is connected to the scanning line whose specific resistance is equal to 1.7 μΩ·cm in parallel therewith, so that the resistance value of the scanning line in the portion with the spacer and that in the portion without a spacer differ. Consequently, voltage drops in the portion with the spacer and the portion without a spacer which are neighboring differ remarkably, luminance gradation (change in brightness) due to such a large different voltage drop is visually recognized, and what is called a “luminance variation” is caused. On the other hand, if there is no spacer, since the luminance gradation is constant (for example, the brightness becomes gradually dark from the left side of the display screen toward the right side of the display screen), it is difficult to visually recognize the luminance gradation.

The thinner the film thickness (5 μm) of Cu of the upper electrode power supply wiring 16 is made for the purpose of reducing the costs, the more the change in scanning line resistance in association with the localization of the conductive adhesive material increases and the more the luminance gradation can be easily seen.

To avoid such a situation, there is a method of smoothing the luminance gradation by uniformly coating the whole scanning line with the conductive adhesive material of the metal paste. However, such a method results in wasteful consumption of resources and an increase in costs.

In the diagrams, component elements having common functions are designated by the same reference numerals and the repetitive explanation about the component elements which have been described once is omitted here to avoid complexity. The scanning line and the upper electrode power supply wiring are the same and it is assumed hereinbelow that the upper electrode power supply wiring is called a scanning line unless otherwise a doubt is raised.

The invention is characterized in that the spacer is arranged on the scanning line in parallel in its longitudinal direction, in the portion where the scanning line and the spacer are conduction-connected by the conductive adhesive material, an anisotropic conductive adhesive material in which a resistance value in the plane direction which perpendicularly crosses the thickness direction, that is, a resistance value along the longitudinal direction of the scanning line is two or more digits larger than that in the thickness direction of the conductive adhesive material is used as a conductive adhesive material.

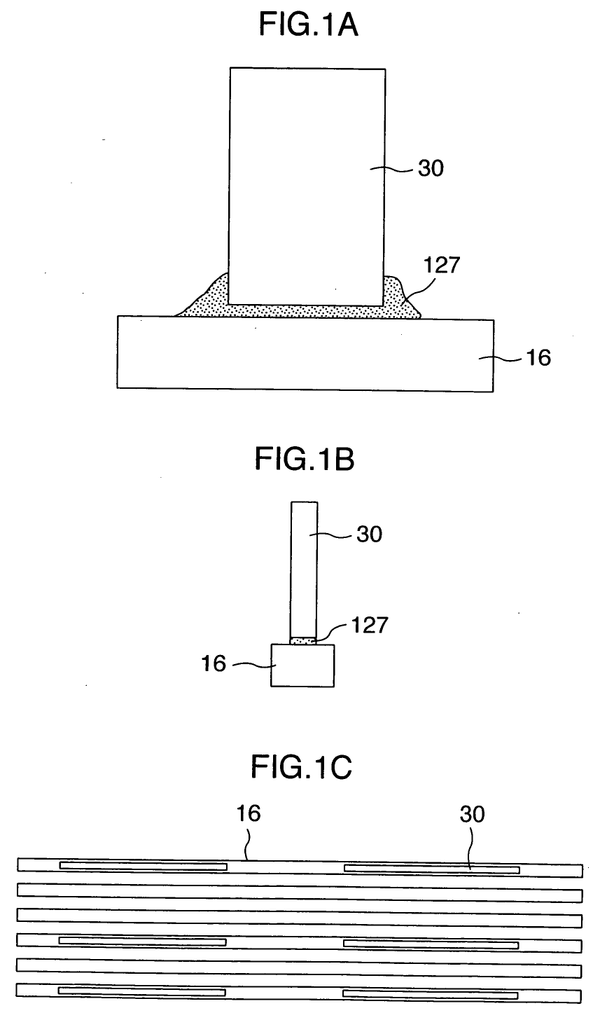

An embodiment 1 will now be described. FIGS. 1A, 1B, and 1C are schematic connection constructional diagrams of scanning lines and spacers formed on a rear substrate of a flat panel display apparatus according to an embodiment of the invention. FIG. 1A is a front view. FIG. 1B is a side elevational view. FIG. 1C is a plan view. In FIGS. 1A to 1C, a plurality of flat plate-shaped spacers 30 are arranged in parallel on the scanning lines 16 along its longitudinal direction and connected to the scanning lines 16 by an anisotropic conductive adhesive material 127.

The anisotropic conductive adhesive material is a material obtained by dispersing conductive particles into an insulative adhesive agent using a thermosetting resin as a main component and used as, for example, an anisotropic conductive film (usually, abbreviated to “ACF”) molded in a film shape. The anisotropic conductive adhesive material shows conductivity in the thickness direction where a pressure is applied and insulation performance in the plane direction which perpendicularly crosses the pressing direction and has been disclosed in, for example, JP-A-2003-308728.

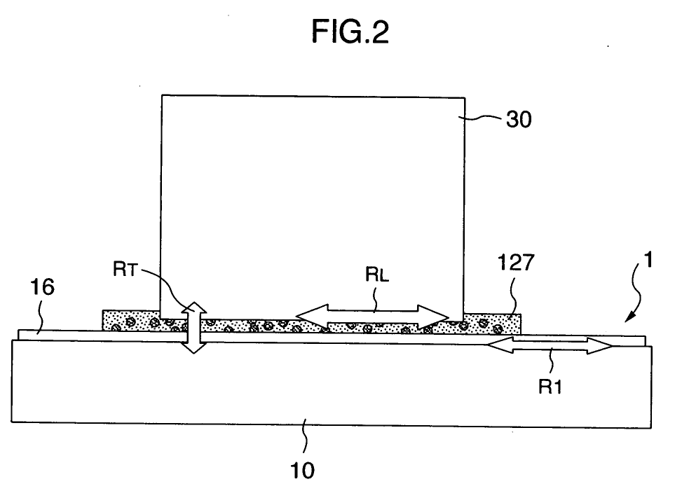

FIG. 2 is a schematic diagram showing a relation between a resistance value of the anisotropic conductive adhesive material in the plane direction as a longitudinal direction of the scanning line and a resistance value of the conductive adhesive material in the thickness direction which perpendicularly crosses the longitudinal direction of the scanning line. In FIG. 2, in the anisotropic conductive adhesive material 127 which is used in the invention, a resistance value R_{L} in the plane direction as a direction along the scanning line 16 is two or more digits larger than the resistance value R_{T} in the thickness direction of the connecting portion of the spacer and the scanning line 16. If the resistance value R_{L} is two or more digits larger than the resistance value R_{T}, an influence of the resistance value R_{L} of the resistor which is connected in parallel with a resistor R1 of the scanning line is equal to 1% or less and it is difficult to visually recognize the luminance gradation as a luminance variation.

As disclosed in JP-A-2003-226858 showing the hardening action similar to that of the thermosetting adhesive agent, according to the anisotropic conductive adhesive material 127, metallic particles or metal-coated plastic particles are dispersed in the adhesive agent, thereby causing the anisotropy showing the conductivity in the thickness direction and showing the insulation performance in the plane direction. That is, the adhesive agent serving as a base material is made of a silicon resin containing at least phenylheptamethyl cyclotetra siloxane and 2,6-cis-diphenyl hexamethyl cyclotetra siloxane and thermally hardened at temperatures of 200 to 400° C. As for the FED, ordinarily, after the display substrate and the rear substrate are assembled as a display panel, a heat treatment step is executed at about 300° C. Therefore, the present adhesive agent can be preferably used.

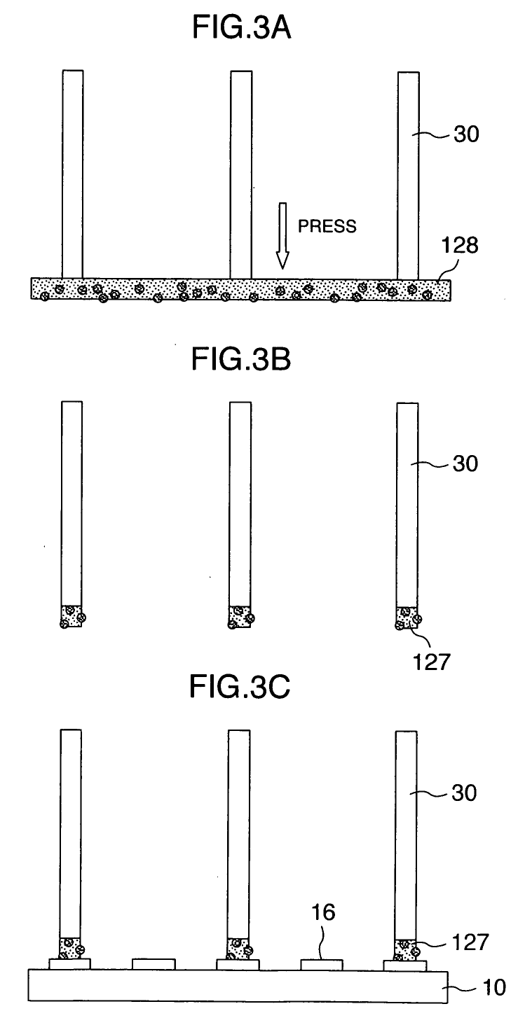

A connecting step of the spacers and the scanning lines is shown in FIGS. 3A to 3C. First, referring to FIG. 3A, the spacers 30 are perpendicularly pressed onto a conductive adhesive sheet 128 while heating their peripheries to 120° C. and pressurized. By pressing them with the heat, the anisotropic conductivity in which the resistance value in the pressing direction is small and the resistance value in the direction which perpendicularly crosses the pressing direction is large appears. As shown in FIG. 3B, when the spacer 30 is pulled, since the conductive adhesive sheet 128 has already been softened by the heating, the anisotropic conductive adhesive material 127 is peeled off from the conductive adhesive sheet 128 and adhered to the spacer 30. Then, those components are cooled. Subsequently, as shown in FIG. 3C, the spacer 30 to which the anisotropic conductive adhesive material 127 has been adhered is temporarily adhered onto the scanning line 16 formed on the rear substrate 1 at 120° C. and, thereafter, they are cooled.

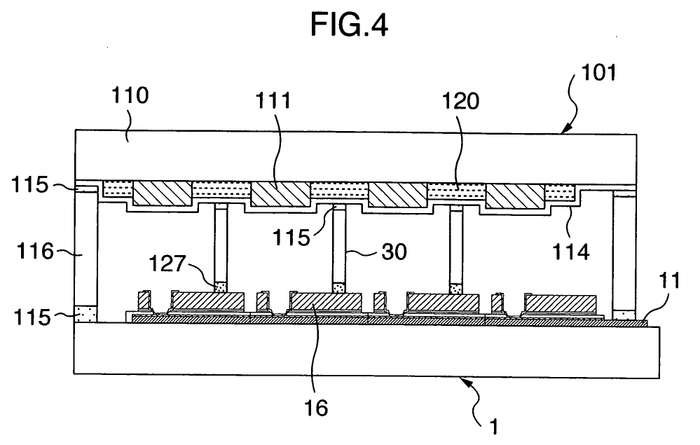

As mentioned above, the rear substrate 1 onto which the spacers have temporarily been fixed and the substrate 101 on which the phosphor and the metal back have been formed are assembled through the supporting frames 116 as shown in FIG. 4, thereby completing the flat panel display apparatus. Joint portions of the substrate 101 and the supporting frames 116 and joint portions of the rear substrate 1 and the supporting frames 116 are coated with the frit glass 115, joint portions of the spacers 30 and the substrate 101 is coated with the anisotropic conductive adhesive material 127, and they are baked at 400 to 450° C. and fixedly seal-bonded. Joint portions of the rear substrate 1 and the spacers 30 which have temporarily been fixed by the anisotropic conductive adhesive material 127 are also hardened by the baking and the spacers 30 are also adhered and fixed to the rear substrate 1.

Naturally, in place of the frit glass 115, the adhesive agent made of the silicon resin containing at least phenylheptamethyl cyclotetra siloxane and 2,6-cis-diphenyl hexamethyl cyclotetra siloxane as a base material of the anisotropic conductive adhesive material 127 can be also used in the joint portions of the substrate 101 and the supporting frames 116 and the joint portions of the rear substrate 1 and the supporting frames 116. By using such an adhesive agent, vacuum airtightness of the FED can be further improved as also disclosed in JP-A-2003-226858.

As mentioned above, according to the invention, since the anisotropic conductive adhesive material is used for the conduction connection of the spacers and the scanning line as a row-directional wiring on which the spacers are arranged, the resistance value R_{T} in the thickness direction of the conductive adhesive material can be reduced, the resistance value R_{L} in the plane direction along the scanning line which perpendicularly crosses the thickness direction of the conductive adhesive material can be increased, and the influence of the resistance value R_{L} of the resistor which is in parallel with the scanning line resistor R1 can be ignored. Thus, the luminance variation occurring in the portion with the spacer and the portion without a spacer can be preferably reduced.

In the embodiment mentioned above, since the spacers can be thickened, the invention has been described as an example in which the spacers can be arranged on the scanning line as a row-directional wiring and along the scanning line. However, the invention is not limited to such an example but can be also naturally applied to the case where the spacers are arranged on the scanning line as a column-directional wiring and along the signal line (for example, refer to FIG. 25 of JP-A-2002-260563).

The invention can be also applied to the case where the spacers are not in the flat-plate shape but are in an L-character shape or a T-character shape obtained by combining two flat plate-shaped spacers. For example, in the case where one spacer is arranged on the scanning line and in parallel therewith and the other spacer is arranged so as to traverse a plurality of scanning lines, in the case of the spacer in the transverse direction, since a resistance film formed on the spacer surface has a high resistance (for example, in paragraph No. 0121 of JP-A-2000-164129, a specific resistance is equal to 1×10² to 1×10⁶ Ω·cm), even if the spacer traverses the scanning lines, an interference between the adjacent scanning lines through the spacer can be ignored. On the other hand, in the case of the spacer in the scanning line direction, the luminance variation can be preferably reduced by the anisotropic conductive adhesive material.

Naturally, the invention can be also similarly applied to the case of a lattice shape (box shape) in which a plurality of spacers are combined.

It should be further understood by those skilled in the art that although the foregoing description has been made on embodiments of the invention, the invention is not limited thereto and various changes and modifications may be made without departing from the spirit of the invention and the scope of the appended claims.

1. A flat panel display apparatus comprising:
a rear substrate in which a number of cold cathode devices for emitting electrons are formed on an insulative substrate;
a display substrate which is arranged so as to face said rear substrate and in which phosphors that are excited by electron beams from said cold cathode devices and emit light are arranged in a matrix shape on a translucent substrate arranged;
supporting members which are arranged between said rear substrate and said display substrate and maintain intervals between them; and
frame members,
wherein said rear substrate, said display substrate, and said frame members are arranged to form a closed space, said rear substrate has said cold cathode devices in crossing portions of row-directional wirings and column-directional wirings which perpendicularly cross, and said supporting members are adhered and arranged on said row-directional wirings or said column-directional wirings with an anisotropic conductive adhesive material.

2. A device according to claim 1, wherein said supporting members have flat portions and said flat portions are arranged on said row-directional wirings in parallel with the wiring direction.

3. A device according to claim 1, wherein in said anisotropic conductive adhesive material, a resistance value in the direction which perpendicularly crosses is two or more digits higher than that in the interval maintaining direction of said supporting members.

4. A device according to claim 2, wherein in said anisotropic conductive adhesive material, a resistance value in the direction which perpendicularly crosses is two or more digits higher than that in the interval maintaining direction of said supporting members.

5. A flat panel display apparatus comprising:
a rear substrate in which a number of cold cathode devices for emitting electrons are formed on an insulative substrate;
a display substrate which is arranged so as to face said rear substrate and in which phosphors that are excited by electron beams from said cold cathode devices and emit light are arranged in a matrix shape on a translucent substrate arranged;
supporting members which are arranged between said rear substrate and said display substrate and maintain intervals between them; and
frame members,
wherein a space surrounded by said rear substrate, said display substrate, and said frame members is set to a vacuum atmosphere, said rear substrate has said cold cathode devices in crossing portions of row-directional wirings and column-directional wirings which perpendicularly cross, and said supporting members are adhered and arranged on said row-directional wirings or said column-directional wirings with an anisotropic conductive adhesive material.

6. A flat panel display apparatus according to claim 1, wherein the supporting members comprises a plurality of spacers arranged on the rear substrate.
